(19) United States
(12) Patent Application Publication
(10) Pub. No.: US 2022/0269896 A1
(43) Pub. Date: Aug. 25, 2022

(54) SYSTEMS AND METHODS FOR IMAGE DATA MANAGEMENT

(71) Applicant: GOOGLE LLC, Mountain View, CA (US)

(72) Inventors: Sushant Kulkarni, Kitchener (CA); Samarth Singhal, Kitchener (CA); Lee Payne, Waterloo (CA); Olivia Perryman, Ottawa (CA); Gabriel Reyes, Dexter, MI (US)

(21) Appl. No.: 17/229,437

(22) Filed: Apr. 13, 2021

Related U.S. Application Data
(60) Provisional application No. 63/008,890, filed on Apr. 13, 2020.

(51) Int. Cl. G06K 9/32; G02B 27/01; G02B 27/00; G06F 3/01

(52) U.S. Cl. CPC G06K 9/3258; G02B 27/017; G02B 27/0093; G06F 3/013; G02B 2027/0138; G02B 2027/014

(57) ABSTRACT

Wearable heads-up displays (WHUDs) and methods of operating the WHUDs are provided. An example method of operating a WHUD includes capturing image data representing an image of a live view (LV) by a camera of the WHUD. The method also includes determining an indication of interest associated with the image data. In addition, the method includes selecting at least a portion of the image data based on the indication of interest, and sending the portion of the image data external to the WHUD for processing.

### CROSS-REFERENCE TO RELATED APPLICATIONS

The present application claims priority to U.S. Provisional Patent Application Ser. No. 63/008,890, entitled “Systems and Methods for Image Data Management” and filed on Apr. 13, 2020, the entirety of which is incorporated by reference herein.

### BACKGROUND

Computer systems, handheld devices, and other electronic systems typically employ one or more displays to form still or moving images. Some displays may use a display panel to form the still or moving images. Examples of such display panels include Light Emitting Diode (LED) display panels, Liquid Crystal Display (LCD) panels, and the like. In addition, some displays may use projectors to project still or moving images. Small displays may be used to form, or as a part of, mobile or wearable devices. For example, some displays may form or be part of a wearable heads-up display.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 shows a flowchart of an example method of operating a wearable heads-up display, in accordance with a non-limiting implementation of the present specification.

FIG. 2 shows a schematic representation of an example system which may be used to form or project an image, in accordance with a non-limiting implementation of the present specification.

FIG. 3 shows a partial-cutaway perspective view of an example wearable heads-up display (WHUD), in accordance with a non-limiting implementation of the present specification.

FIG. 4 shows a schematic representation of the WHUD of FIG. 3 sending an example portion of example image data external to the WHUD, in accordance with a non-limiting implementation of the present specification.

FIG. 5 shows a schematic representation of the WHUD of FIG. 3 sending another example portion of other example image data external to the WHUD, in accordance with a non-limiting implementation of the present specification.

FIG. 6 shows a schematic representation of the WHUD of FIG. 3 sending yet another example portion of yet other example image data external to the WHUD, in accordance with a non-limiting implementation of the present specification.

FIG. 7 shows a schematic representation of the WHUD of FIG. 3 sending yet another example portion of yet other example image data external to the WHUD, in accordance with a non-limiting implementation of the present specification.

FIG. 8 shows a schematic representation of the WHUD of FIG. 3 sending yet another example portion of yet other example image data external to the WHUD, in accordance with a non-limiting implementation of the present specification.

FIG. 9 shows a schematic representation of the WHUD of FIG. 3 sending yet another example portion of yet other example image data external to the WHUD, in accordance with a non-limiting implementation of the present specification.

FIG. 10 shows a schematic representation of the WHUD of FIG. 3 sending yet another example portion of yet other example image data external to the WHUD, in accordance with a non-limiting implementation of the present specification.

FIG. 11 shows a schematic representation of the WHUD of FIG. 3 sending yet another example portion of yet other example image data external to the WHUD, in accordance with a non-limiting implementation of the present specification.

FIG. 12 shows a schematic representation of the WHUD of FIG. 3 sending yet another example portion of yet other example image data external to the WHUD, in accordance with a non-limiting implementation of the present specification.

FIG. 13 shows a schematic representation of the WHUD of FIG. 3 sending yet another example portion of yet other example image data external to the WHUD, in accordance with a non-limiting implementation of the present specification.

FIG. 14 shows a schematic representation of the WHUD of FIG. 3 sending yet another example portion of yet other example image data external to the WHUD, in accordance with a non-limiting implementation of the present specification.

FIG. 15 shows a schematic representation of the WHUD of FIG. 3 sending yet another example portion of yet other example image data external to the WHUD, in accordance with a non-limiting implementation of the present specification.

FIG. 16 shows a schematic representation of the WHUD of FIG. 3 sending yet another example portion of yet other example image data external to the WHUD, in accordance with a non-limiting implementation of the present specification.

FIG. 17 shows a schematic representation of an example alternation to an example portion of example image data, in accordance with a non-limiting implementation of the present specification.

FIG. 18 shows a schematic representation of another example alternation to an example portion of example image data, in accordance with a non-limiting implementation of the present specification.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like. In other instances, well-known structures associated with light sources have not been shown or described in detail to avoid unnecessarily obscuring descriptions of the implementations.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

Throughout this specification and the appended claims, the term “carries” and variants such as “carried by” are generally used to refer to a physical coupling between two objects. The physical coupling may be direct physical coupling (i.e. with direct physical contact between the two objects) or indirect physical coupling that may be mediated by one or more additional objects. Thus, the term carries and variants such as “carried by” are meant to generally encompass all manner of direct and indirect physical coupling, including without limitation: carried on, carried within, physically coupled to, secured to, and/or supported by, with or without any number of intermediary physical objects therebetween.

Mobile devices such as wearable heads-up displays (WHUDs) may operate with limited power, computational, and communication bandwidth resources. In such mobile devices, image processing may be a resource intensive operation. In order to reduce the demands placed on the limited resources of the mobile device by image processing, some of the image data may be sent external to the mobile device for processing. For example, the mobile device may send at least a portion of the image data to a desktop computer, laptop computer, smartphone, or other device for processing. Moreover, in some examples, the applications being executed on a mobile device may rely on analysis of or against data sets which are too large or too frequently-updated to allow such analysis to be practical onboard the mobile device. Examples of such applications may include online marketplaces and their large databases, and the like. In some examples, this image data may be processed externally to a WHUD in a mobile device such as a smart phone associated with the WHUD, in the cloud, in one or more servers, at a desktop or laptop computer, and the like. For the same reasons as above, image data may be sent external to the mobile device for processing to complete such analyses.

In order to allow for external processing of the image data captured by a WHUD, the image data must be sent from the WHUD to an external data processor. The sending of image data in itself may require time as well as power and communication bandwidth. As such, the sending of image data external to the WHUD may act as a bottleneck to timely and resource efficient processing of image data. Hereafter, the present disclosure describes such image data transfer with respect to WHUDs. However, unless context dictates otherwise, the present systems and methods are also applicable with other mobile devices.

In order to mitigate the bottleneck caused by the sending of image data external to the WHUD, the image data may undergo preliminary processing by the WHUD to determine an indication of interest associated with the image data. Then a portion of the image that is based on the indication of interest may be selected, and sent external to the WHUD for processing. By sending a portion of the image data instead of the entirety of the image data, the amount of image data that is sent external to the WHUD may be reduced thereby reducing or avoiding the bottleneck caused by the sending of such image data external to the WHUD. This can include sending a portion of a single image, or sending one image or a subset of images of a larger plurality of images.

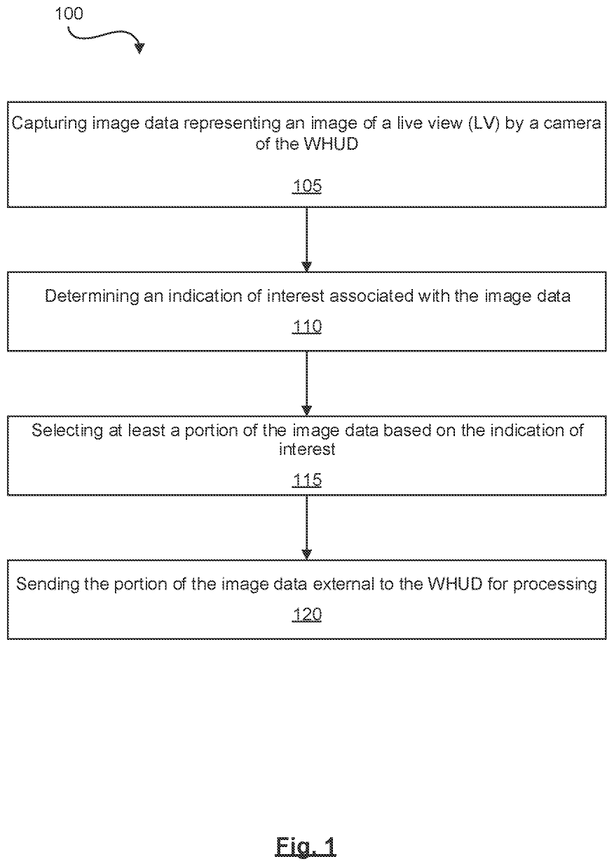

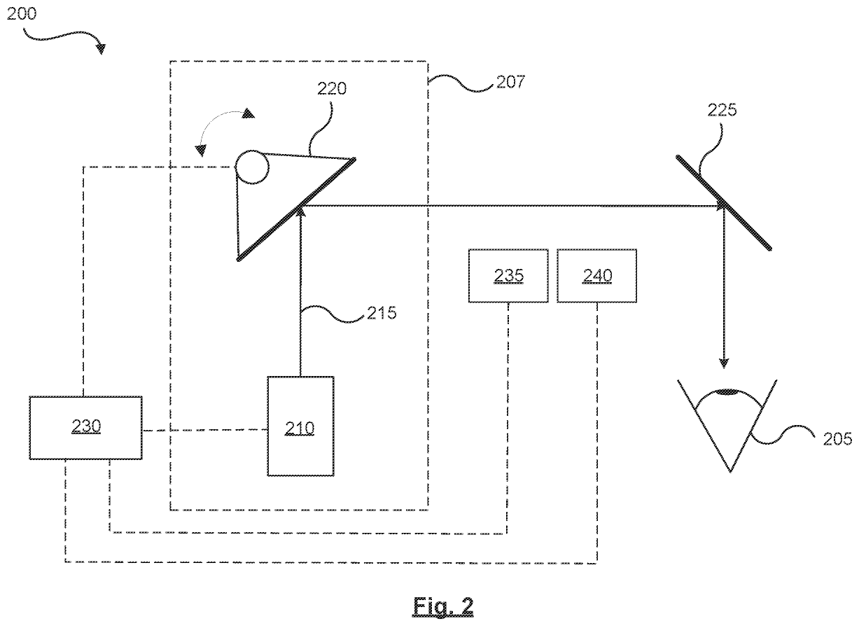

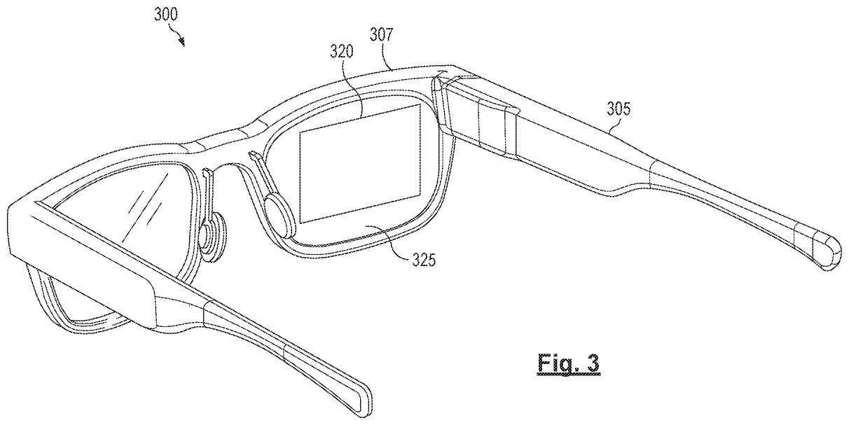

Turning now to FIG. 1, a flowchart of an example method 100 is shown. Method 100 may be used to operate a WHUD. At box 105, image data may be captured by a camera of the WHUD. The image data may represent at least one image of a live view (LV). Example displays and WHUDs are described in greater detail in relation to FIGS. 2 and 3. An LV may represent the actual or physical surroundings of the WHUD. Moreover, in some examples, the LV may represent a portion of the surroundings of the WHUD visible through the WHUD to a user wearing the WHUD.

At box 110, an indication of interest associated with the image data may be determined. In some examples, the indication of interest may include an indication that a region in or feature of the image is of interest. Moreover, in some examples, the indication of interest may include an indication that a given image or frame among a plurality of images or frames may be of interest.

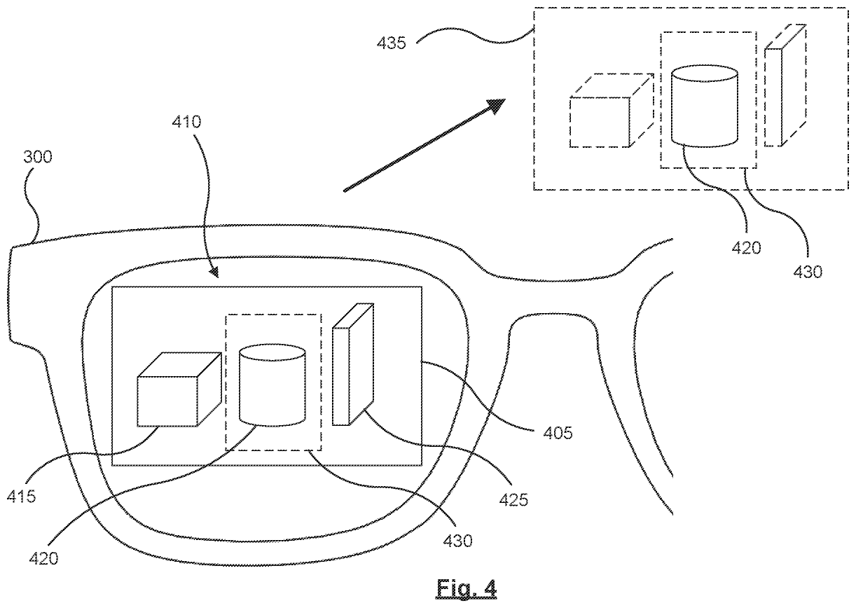

In some examples, a region or feature being of interest may include the image data associated with that region or feature of the image being a candidate for being sent external to the WHUD for processing. Furthermore, in some examples, an image or a region or feature therein being of interest may include that image or the region or feature therein being selected or being determined to be of higher priority for further image data processing. Furthermore, in some examples, the indication of interest may include an indicator or another designation or indication that the given image, or region or feature therein is of interest. The determination of the indication of interest is described in greater detail in relation to FIGS. 4-16.

At box 115, at least a portion of the image data is selected based on the indication of interest. In some examples, this portion of the image data may include a region or feature of interest in the image associated with the image data. Moreover, in some examples, this portion of the image data may include image data associated with a given image or frame selected from among a plurality of images or frames. The selection of the portion of the image data based on the indication of interest is described in greater detail in relation to FIGS. 4-16.

At box 120, the portion of the image data selected in box 115 is sent external to the WHUD for processing. As the WHUD is a mobile device, in some examples the sending may be via wireless data communication. In some examples, such a wireless data communication may use a communication protocol such as Bluetooth™, Wi-Fi™, cellular data, and the like. As discussed above, in some examples, the portion of the image data may be sent to an image data processor external to the WHUD. Moreover, in some examples, this image data processor may be implemented in, be a part of, or incorporated into a mobile device such as a smart phone, the cloud, one or more servers, virtual or virtualized data processors, and the like.

In some examples, sending external to the WHUD for processing only the portion of the image data which corresponds to the indication of interest may reduce the amount of image data that is sent external to the WHUD for processing, thereby reducing the resource demands and the bottleneck associated with communicating image data external to the WHUD.

Turning now to FIG. 2, a schematic representation of an example system 200 is shown. System 200 may be used to form or project an image viewable by an eye 205 of a viewer. System 200 may also be referred to or described as an image projection device, a display device, a display system, or a display. System 200 may perform the functions and have the features of method 100 and the other methods described herein. For example, system 200 may have the features or perform the functions described herein in relation to FIGS. 4-18.

System 200 may include a light engine 207 to generate a display light 215. Light engine 207 may include a light source 210 and a spatial modulator 220. Light source 210 may include at least one laser, at least one light emitting diode, and the like. Spatial modulator 220 may receive display light 215 from light source 210. In some examples, spatial modulator 220 may include a movable reflector, a micro-electro-mechanical system (MEMS), a digital micromirror device (DMD), and the like.

While FIG. 2 shows light engine 207 including a light source and a spatial modulator, it is contemplated that in some examples the light engine need not include a spatial modulator. In some such examples, the light engine may include a micro-display, and the like.

System 200 may also include a display optic 225 to receive display light 215 from spatial modulator 220 and direct the display light towards eye 205 of a viewer. In some examples, display optic 225 may include a light guide having an optical incoupler and an optical outcoupler. Moreover, in some examples system 200 may be a part of or incorporated into a wearable heads-up display (WHUD). Such a heads-up display may have different designs or form factors, such as the form factor of eyeglasses, as is described in greater detail in relation to FIG. 3. In examples where system 200 is in the form factor of glasses, display optic 225 may be on or in a lens of the glasses.

In addition, system 200 includes a controller 230 in communication with light source 210 and spatial modulator 220. Controller 230 may control light source 210 and spatial modulator 220 to project an image. In some examples, the image to be projected may be a still image, a moving image or video, an interactive image, a graphical user interface, and the like.

In some examples, the controllers described herein such as controller 230 may include a processor in communication with a non-transitory processor-readable medium. The processor-readable medium may include instructions to cause the processors to control the light source and the spatial modulator as described in relation to the methods and systems described herein. Moreover, in some examples the controllers may be free-standing components, while in other examples the controllers may include functional modules incorporated into other components of their respective systems.

Furthermore, in some examples the controllers or their functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

In some examples, system 200 may also include a camera 235 to capture images. In some examples, such images may include images of LVs of the surroundings of system 200. Camera 235 may be in communication with controller 230. Controller 230 may obtain directly or indirectly from camera 235 image data corresponding to the images captured by camera 235.

In addition, in some examples, system 200 may include a gaze tracking module 240 in communication with controller 230. Module 240 may determine the direction of gaze of eye 205 of the user of system 200. In other words, module 240 may be used to determine what or where the user is looking or gazing. In some examples, module 240 may include a light emitter and a light receiver. Furthermore, in some examples, the light emitter and receivers may include an infrared (IR) light emitter and receiver. The light emitter and receivers are generally configured to capture one or more images of eye 205. The module 240 is configured to analyze the one or more images of eye 205 to the determine the direction of gaze. For example, the module 204 can use one or more feature detection techniques, such as edge detection and feature comparison, to identify an iris or other portion of the eye 205, or any combination of portions of the eye 205. Based on the identified features of the eye 205, the module 204 can determine the direction of gaze, such as by comparing the identified features with one or more stored features, wherein each stored feature is associated with a different gaze direction. It is contemplated that in some examples gaze tracking modules having structures or components other than IR light emitters and receivers may also be used.

In FIG. 2, in some examples system 200 need not include a camera 235 or module 240. Moreover, in some examples, the functions of camera 235 and module 240 may be performed by modules external to system 200 and in communication with system 200.

Turning now to FIG. 3, a partial-cutaway perspective view of an example wearable heads-up display (WHUD) 300 is shown. WHUD 300 includes a support structure 305 that in use is worn on the head of a user and has the general form factor and appearance of an eyeglasses (e.g. sunglasses) frame. Eyeglasses or sunglasses may also be generically referred to as “glasses”. Support structure 305 may carry components of a system to display an image, such as system 200. For example, the light source module may be received in a space 310 in a temple arm of support structure 305.

The spatial modulator of the systems described herein may be received in or be part of component 315 of support structure 305. The spatial modulator in turn may direct the display light onto a display optic 320 carried by a lens 325 within a frame 307 of support structure 305. In some examples, display optic 320 may be similar in structure or function to display optic 225. Moreover, in some examples display optic 320 may include a light guide including an optical incoupler and an optical outcoupler. Moreover, WHUD 300 may include a camera a gaze tracking module 335, which may be similar to camera 235 and module 240 respectively.

Referring back to the functions and features of method 100, and the corresponding functions and features of system 200 and WHUD 300, in some examples, determining the indication of interest may include determining a region of interest in the image. In some examples, this region of interest may include a portion of or all of the image. Moreover, in some examples, the region of interest may include one region, or a plurality of regions.

Furthermore, in some examples, determining the region of interest may include defining at least a portion of the region of interest in the image by defining a boundary associated with a feature of interest in the image. In some examples, the feature of interest may include one or more entities in the image such as objects, persons, faces, QR Codes, or other visual features or properties of the image.

Moreover, in some examples, such a boundary may demarcate the feature of interest. In some examples, the boundary may capture only the feature of interest. Furthermore, in some examples, the boundary may capture the feature of interest and additional features or regions of the image. In some examples, an image recognition module may be used to detect the feature of interest or to define the boundary associated with the feature of interest. In addition, in some examples, the image recognition module may include a trained machine learning model, a neural network, and the like. In some examples the image recognition module may be implemented in software, hardware, or a combination of software and hardware.

In some examples, defining the boundary associated with the feature of interest may include defining one or more bounding boxes, set of points, bounding curves, and the like. FIG. 4 shows an example image 405 of a live view 410 as seen by the user of WHUD 300. Image 405 includes three objects 415, 420, and 425. Based on the image data associated with image 405, an image recognition module may define a bounding box 430 around object 420 to define the region of interest in image 405. In some examples, the image recognition module may operate onboard WHUD 300. Moreover, in some examples the image recognition module may select or recognize object 420 on a basis which may include a predetermined basis, a dynamically-determined basis, a user-selected basis, a machine-learned basis, and the like.

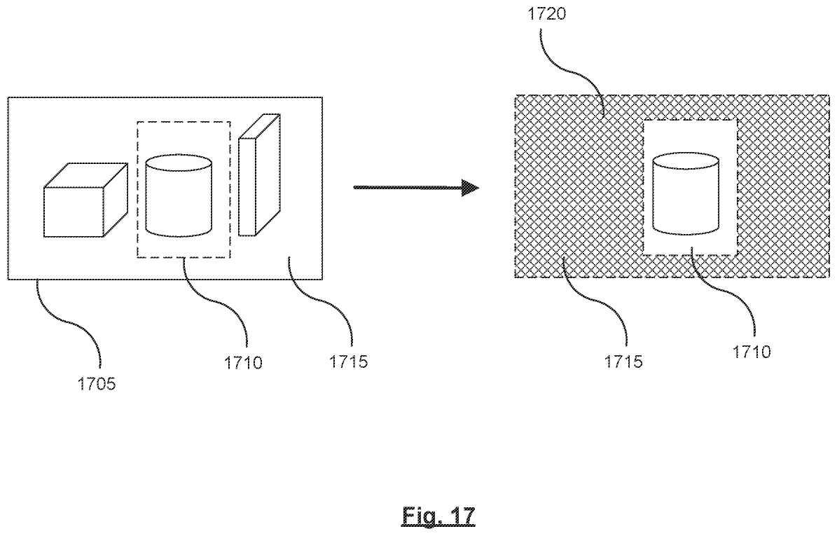

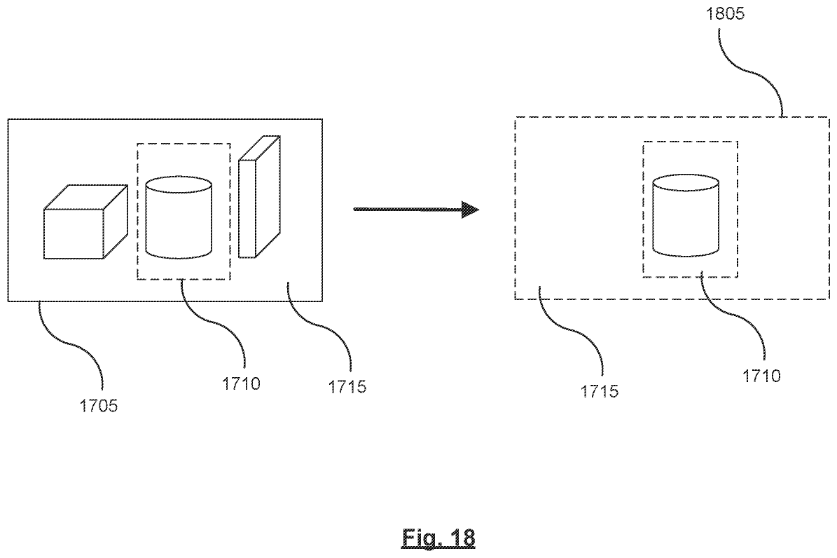

Based on bounding box 430, a portion 435 of the image data associated with image 405 may be sent external to WHUD 300 for processing. Portion 435 may include the portion of the image data associated with image 405 that is within bounding box 430. When depicting portion 435, the portions of the image outside of bounding box 430 are shown in dashed lines to indicate that the portions outside of bounding box 430 may form no part of portion 435 of the image data. Moreover, in some examples, the portions of the image that are outside of bounding box 430 may be altered in or deleted from portion 435 of the image data that is sent external to WHUD 300 for processing. Examples of such alteration or deletion are described in detail later with reference to FIGS. 17 and 18.

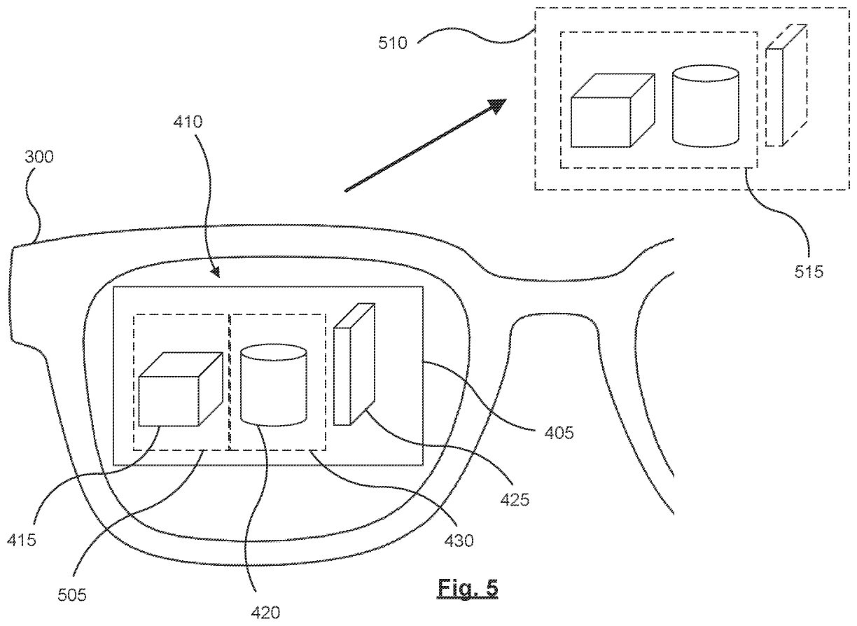

In addition, in some examples, determining the region of interest may include defining the region of interest in the image by defining a plurality of boundaries associated with one or more features of interest in the image. FIG. 5 shows live view 410 similar to the live view shown in FIG. 4. A difference between FIGS. 4 and 5 is that in FIG. 5 both objects 415 and 420 are identified as being features of interest. As such, bounding boxes 505 and 430 are placed around objects 415 and 420 respectively.

Portion 510 of the image data associated with image 405 that is sent external to WHUD 300 for processing may correspond to a region of interest 515 that is a union of bounding boxes 430 and 505. It is contemplated that in some example portion 510 may include the image data corresponding to bounding boxes 430 and 505 individually. Moreover, in some examples, portion 510 may include image data associated with a region of interest defined by a bounding box or bounding shape that encompasses bounding boxes 430 and 505. Similar to FIG. 4, when depicting portion 510, portions of image 405 outside of region of interest 515 are shown in dashed lines to indicate that the image data corresponding to the portion of image 405 outside of region of interest 515 may be deleted from portion 510 or may be altered in portion 510.

Moreover, in some examples where the region of interest includes a plurality of boundaries, position data associated with the positions of each of the features of interest relative to the image may also be sent external to WHUD 300 for processing. For example, positions of bounding boxes 430 and 505 relative to image 405 may be sent external to WHUD 300 along with portion 510 of the image data corresponding to image 405.

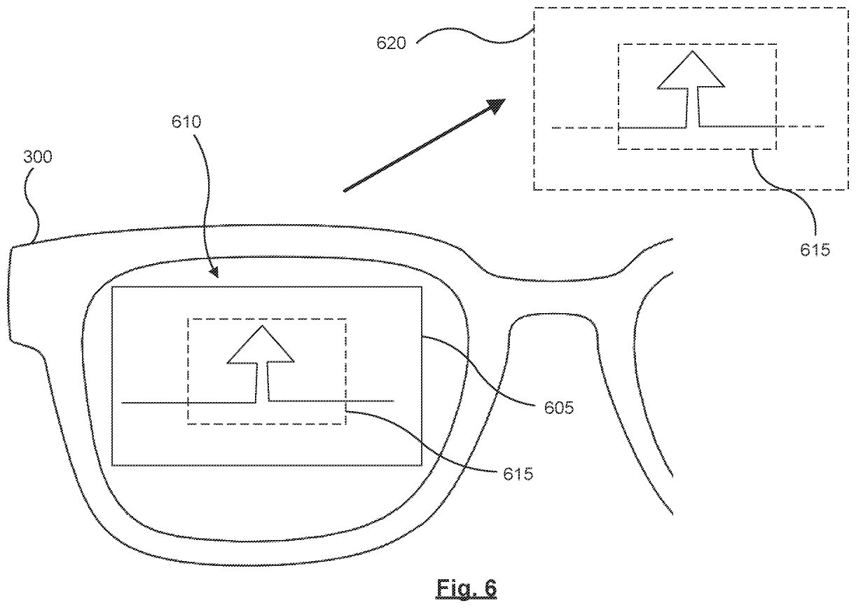

Furthermore, in some examples, determining the region of interest may include designating a central portion of the image as the region of interest. It is contemplated that this central region may have different shapes and sizes relative to the image. FIG. 6 shows an image 605 corresponding to a live view 610. A central portion 615 of image 605 may be designated as the region of interest. It is contemplated that in some examples, the central portion may have a shape or size relative to image 605 that is different than the shape or size of central portion 615.

A portion 620 of the image data corresponding to image 605 may be sent external to WHUD 300 for processing. In depicting portion 620, the portions of image 605 outside of central portion 615 are shown in dashed lines to indicate that in portion 620 image data corresponding to the portions of image 605 outside of central portion 615 may be deleted or altered.

In addition, in some examples, the region of interest may be determined based on the application that is being executed by a controller of the WHUD. For example, this controller may be similar to controller 230 of system 200, and the like. The region of interest then may be determined based on the application. For example, if the application being executed is a photo application, the region of interest may be determined to be most or all of the field of view or the image captured by the camera of the WHUD. Furthermore, if the application being executed is a business directory application which provides information about businesses once the user of the WHUD looks at the sign or name of those businesses, the regions of interest in the images may be those which contain store signs or names.

Moreover, in some examples, determining the region of interest may include determining a location of the WHUD, and determining the region of interest based on the location. For example, if the WHUD is determined to be in a private place such as a home, the regions of interest may be selected to exclude faces to maintain privacy. Moreover, if the WHUD is determined to be in a classroom or lecture hall, the regions of interest that are selected may correspond to the blackboard, the projection screen, or the stage in front of the classroom or lecture hall. In addition, if the location of the WHUD is determined to be in a store or shopping mall, the regions of interest may be selected to correspond to objects that the user of the WHUD is looking at, which objects the user may be interested in researching or purchasing. In some examples, such objects may include handheld objects, and the like.

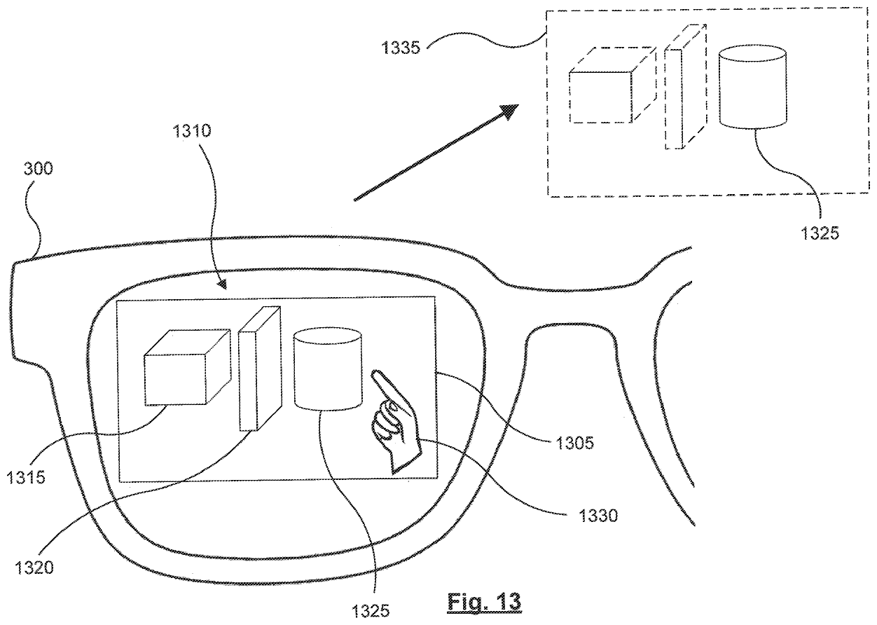

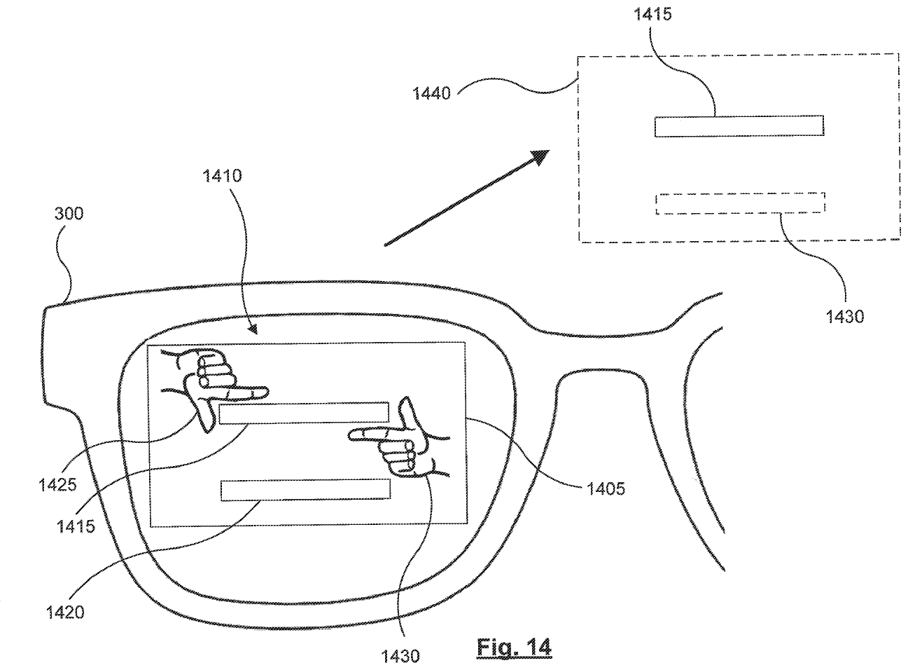

Furthermore, in some examples, determining the region of interest may include receiving user input at the WHUD, and determining the region of interest based on the user input. In some examples, this user input may include visual input to indicate which portions or features in the image of the live view the user is interested in. Examples of such visual inputs are described in greater detail in relation to FIGS. 13 and 14. In addition, in some examples, the user input may include voice, touch, or other types of input received at the WHUD directly or indirectly from the user. For example, the user may issue a voice query to the WHUD asking “how much is this mug?” In response to this user input, the region of interest may be determined to be a portion of the image corresponding to the live view seen through the WHUD, which portion corresponds to a handheld object or to a mug.

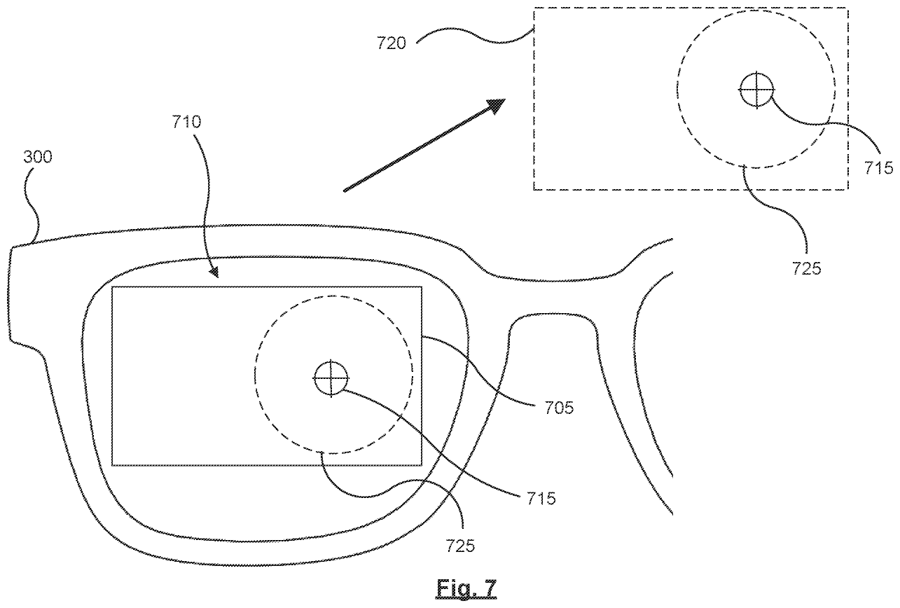

In some examples, determining the region of interest may include determining an area of focus in the LV associated with the user wearing the WHUD. The region of interest then may be determined based on the area of focus. In some examples, determining the area of focus may include determining that the user of the WHUD is gazing at a given region of the image corresponding to the LV. The given region may then be designated as the area of focus. In FIG. 7, image 705 corresponds to LV 710. A gaze tracking module may be used to determine that the user of WHUD 300 is gazing at gaze target 715 or at a given region 725 corresponding to gaze target 715. In some examples, region 725 may include a region of image 705 within a given distance or radium of gaze target 715.

A portion 720 of the image data corresponding to image 705 may then be sent external to WHUD 300 for processing. Portion 720 may include a portion of the image data of image 705 corresponding to region 725. Portion 720 may exclude, or may include an altered version of, the portion of the image data of image 705 corresponding to the portions of image 705 outside of region 725.

Moreover, in some examples, determining the region of interest may include determining a distance of an entity or a given region of the image from the camera of the WHUD. The given entity or region may then be designated as the entity or region of interest if the distance between the entity or region of interest and the camera is below a distance threshold. In some examples, the WHUD may use stereo or 3D imaging to determine the distance between the given region and the camera. Moreover, in some examples, the WHUD may include a distance or range finding module to determine the distance between the given region and the camera. Furthermore, in some examples, the WHUD may use the relative sizes of the various objects in the image to estimate or determine the distance between the given region and the camera. It is also contemplated that in some examples, the given region may include or be indicated by a given entity, object, or visual feature in the image.

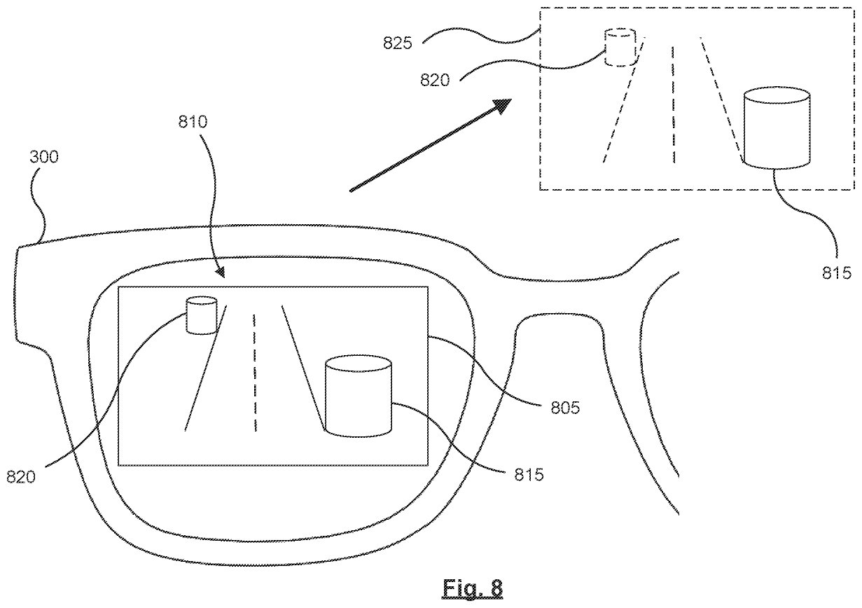

FIG. 8 shows an image 805 of a LV 810. Image 805 includes a first object 815 that is closer to a camera of WHUD 300, and a second object 820 that is relatively further from the camera. In some examples, the distance between object 815 and the camera may be smaller than a distance threshold. In such examples, object 815 or a given region of image 405 corresponding to object 815 may be designated as the region of interest. Portion 825 of the image data corresponding to 805 may be selected and sent external to WHUD 300 or processing. In the depiction of portion 825, portions of image 805 outside of object 815 are shown in dashed lines to indicate that in portion 825 the portions of the image data corresponding to image 805 outside of object 815 may be deleted or otherwise altered.

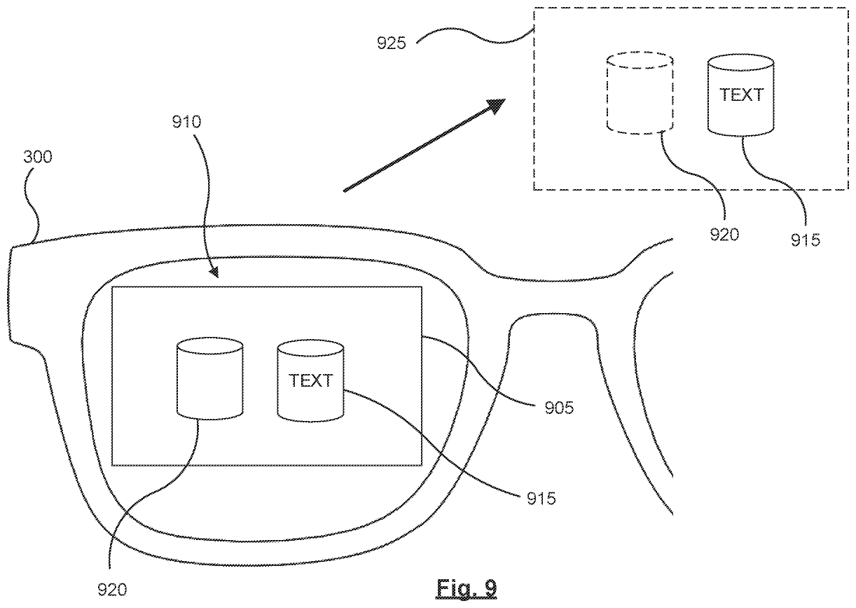

In addition, in some examples, determining the region of interest may include determining the presence of text in a given region of the image. The given region may be designated as the region of interest if text is present in the given region. FIG. 9 shows an image 905 of a LV 910. Image 905 includes a first object 915 including text and a second object 920 which does not include text. Including text may include having letters, words, or other forms of text visible on an outer surface of an object or entity.

Since object 915 is an object that includes text, object 915 or the region of image 905 corresponding to object 915 may be designated as the region of interest in image 905. A portion 925 of the image data corresponding to image 905 may be sent external to WHUD 300 for processing. In depicting portion 925, portions of image 905 outside of object 915 are shown in dashed lines to indicate that in portion 925 portions of the image data corresponding to image 905 that are outside of object 915 may be deleted or altered. In other words, in portion 925 the entities or regions shown in solid lines correspond to the entities or regions of interest. In some examples, the detection of text may be done on board WHUD 300 using for example an image recognition module, a text or character recognition module, and the like.

In addition, in some examples, the regions or features of interest may be determined based on whether text that is detected in the image is legible. Moreover, in some examples, the determination of legibility may include determining whether the text is of sufficient quality to be processed using Optical Character Recognition (OCR). Furthermore, in some examples, legibility may be a function of whether the text is close enough to the camera of WHUD 300 to be discerned or recognized. Moreover, in some examples, legibility may be a function of the inherent quality or legibility of the text itself.

Furthermore, in some examples, an overlap between legible text and another object or entity in the image may be used as an indication that the combination of the text and the other object or entity may represent an entity or region of interest.

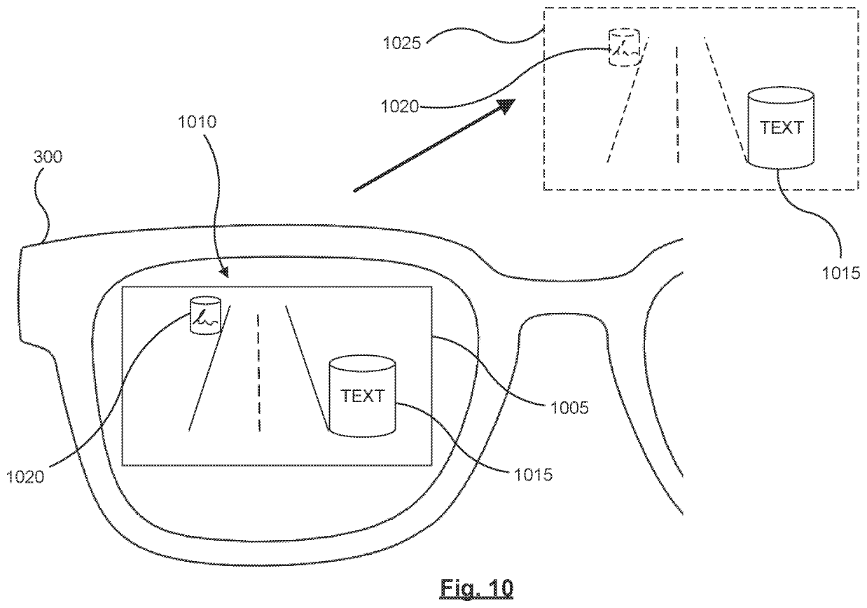

FIG. 10 shows an image 1005 of a LV 1010. Image 1005 includes a first object 1015 and a second object 1020. Object 1015 may include text that is legible, and object 1020 may include text that is not legible. In the example of FIG. 10, the text on object 1020 may be illegible because object 1020 is further from the camera than object 1015. As such, object 1015 or the region of image 1005 corresponding to object 1015 may be selected as the object or region of interest of image 1005. Based on this determination of the feature or region of interest in image 1005, a portion 1025 of the image data corresponding to image 1005 may be sent external to WHUD 300 for processing.

In the depiction of portion 1025, object 1015 is shown in solid lines, whereas the portions of image 1005 outside of object 1015 are shown in dashed lines to indicate that in portion 1025 the portions of the image data corresponding to image 1005 outside of object 1015 may be deleted or otherwise altered. In other words, portion 1025 may correspond to a portion of the image data corresponding to image 1005, which portion corresponds to object 1015.

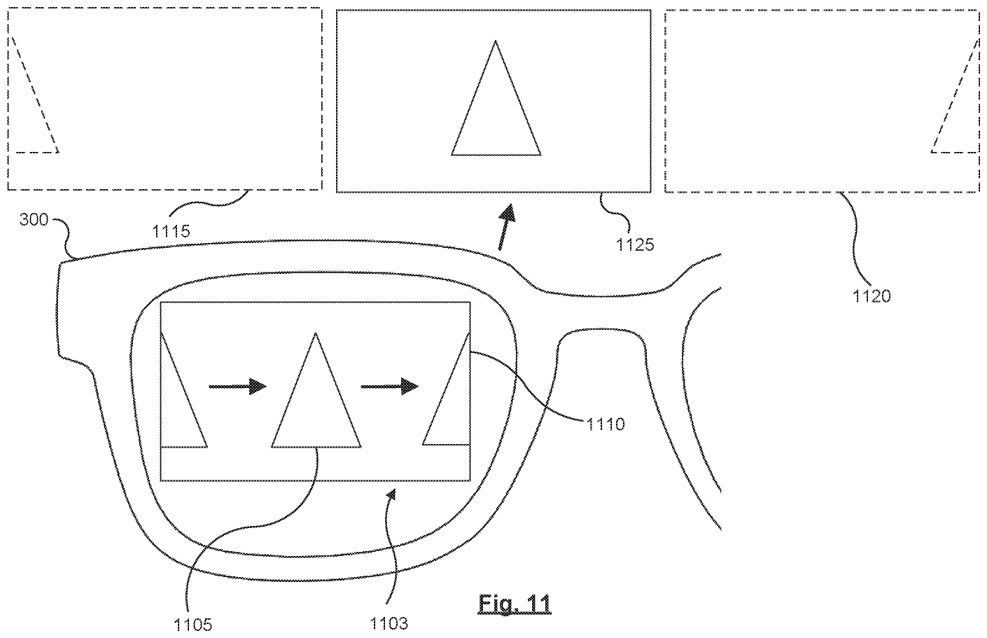

In addition, in some examples, determining the indication of interest may include detecting an entity of interest in the image based on the image data. In some such examples, sending the portion of the image data external to the WHUD may include sending an entirety of the image data external to the WHUD for processing if the entity of interest is detected in the image data. FIG. 11 shows a LV 1103 of an entity of interest 1105 passing through a field of view 1110 of a camera of WHUD 300. The camera may capture three images or frames 1115, 1120, and 1125 over time of LV 1103. An image recognition module may be used to look for or detect entity of interest 1105 in these frames or images.

In frames 1115 and 1120, entity of interest 1105 is not detected. In frames 1115 and 1120 entity of interest 1105 may not be detected because the entirety of entity of interest 1105 is not present in either of these frames. In the case of frame 1125, the entity of interest 1105 is detected in the frame. As such, the indication of interest is associated with frame 1125. On this basis, frame 1125 may be selected from among frames 1115, 1120, and 1125 to be sent external to WHUD 300 for processing. In FIG. 11, frame 1125 is shown in solid lines to indicate that frame 1125 is selected for being sent external to WHUD 300 for processing. Frames 1115 and 1120 are shown in dashed lines to indicate that these frames are not selected for being sent external to WHUD 300 for processing.

In some examples, determining the indication of interest may include analyzing the image data onboard the WHUD using a label classifier to determine one or more labels associated with features or entities present in the image. Furthermore, in some examples, this label classifier may include a trained machine learning model, and the like. In some examples, the determination of whether to send the image data external to the WHUD may be based on the labels assigned by the label classifier to the features or entities in the image. For example, the image data may be sent external to the WHUD if the labels, or their corresponding image features or entities, are useable by or appropriate to an application being executed or an activity being performed by the WHUD. As an example, if a shopping application is being executed, a label classifier can determine whether image data includes representations of any tangible objects which may be purchasable. If the label classifier only identifies non-purchasable features (e.g. faces, landscapes), the WHUD may determine that the image data should not be sent external to the WHUD. As another example, if a facial recognition application is being executed, the WHUD may only determine that image data should be sent external to the WHUD if the label classifier identifies at least one face represented in the image data.

In addition, in some examples, determining the indication of interest may include comparing the image data with other image data associated with another image captured by the camera of the WHUD. In some such examples, sending the portion of the image data external to the WHUD may include sending an entirety of the image data external to the WHUD for processing if a difference between the image data and the other image data is greater than a threshold difference. In some examples, the scheme may be similar to, or described as, a Delta Compression scheme used for compressing image data.

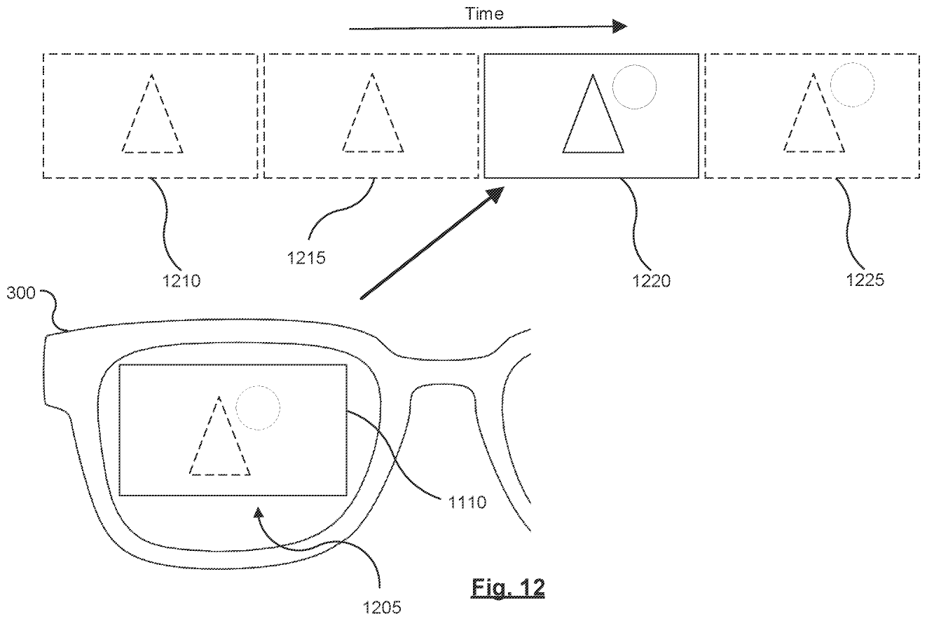

In such examples, image data corresponding to images that exhibit at least the threshold difference from previous images are selected and associated with the indication of interest. In other words, when an image or frame contains a sufficiently large change relative to the previous images or frames, i.e. when the change is greater than the threshold difference, that image or frame is selected as being of interest and is sent external to the WHUD for further processing. FIG. 12 shows a LV 1205 visible through field of view 1110 of the camera of WHUD 300. The camera may be capturing multiple images or frames over time as LV 1205 changes over time. Frames 1210, 1215, 1220, and 1225 show four example frames that may be captured by the camera of WHUD 300 over time.

FIG. 12 shows that there is no change between frame 1215 and 1210. The LV and the corresponding image/frame does change between frame 1220 and 1215. In other words, the subject matter or content of frame 1220 is different then the corresponding subject matter or content of frame 1215. Moreover, frame 1225 is unchanged when compared to frame 1220. For each of frames 1210, 1215, 1220, and 1225, a given frame may be compared to one or more previous frames. If the given frame is sufficiently different than the one or more previous frames, then that given frame may be associated with the indication of interest, and the image data associated with the entirety of that given frame may be sent external to WHUD 300 for processing. In some examples, being sufficiently different may include having a difference relative to the previous frame that is greater than a threshold difference.

In FIG. 12 frame 1215 is not sufficiently different from its previous frame 1210, and as such frame 1215 is not selected for being sent external to WHUD 300. Frame 1220 is sufficiently different from its previous frame 1215, and as such frame 1220 is selected for being sent external to WHUD 300 for processing. Furthermore, frame 1225 is not sufficiently different from its previous frame 1220, and as such frame 1225 is not selected for being sent external to WHUD 300. FIG. 12 shows frame 1220 in solid lines to indicate that frame 1220 is selected for being sent external to WHUD 300 for processing. Moreover, FIG. 12 shows frames 1210, 1215, and 1225 in dashed lines to indicate that these frames are not selected for being sent external to WHUD 300 for processing.

Furthermore, in some examples, location or inertial measurement data associated with the WHUD may be used to determine whether to activate Delta Compression or a similar difference-based compression scheme. In some examples, location data may be obtained from Global Positioning System (GPS) or wireless connection or triangulation data such as wireless connections to cellular towers or Wi-Fi™ hotspots. If location data indicates that the WHUD has not moved significantly relative to its surroundings for a period of time, a difference-based compression scheme may be activated to take advantage of the fact that such lack of movement may indicate that many of the image frames captured by the WHUD may be similar to one another.

Moreover, in some examples, inertial measurements may include measurements such as acceleration, rotation, and the like. In some examples, such inertial measurements may be provided by an Inertial Measurement Unit (IMU) of the WHUD. Such inertial measurements may also be used to determine whether the WHUD is moving. If the WHUD is determined not to be moving, or if movements are determined to be smaller than a movement threshold, a difference-based compression scheme may be activated to take advantage of the fact that such lack of movement may indicate that many of the image frames captured by the WHUD may be similar to one another.

In addition, in some examples, determining the region of interest may include detecting at least one marker of interest in the image, which detection may be based on the image data associated with the image. The region of interest then may be determined based on the marker of interest. In some examples the marker of interest may be detected using an image detection module, and the like. FIG. 13 shows an image 1305 of a LV 1310 captured by the camera of WHUD 300. Image 1305 includes three objects 1315, 1320, and 1325. Image 1305 also includes a marker of interest 1330 in the form of a human hand with the index finger pointing at object 1325. It is contemplated that in some examples, the marker of interest may be different than human fingers. For example, the marker of interest may include a physical pointer, a laser pointer, or a different type of pointer or other marker of interest.

The region or feature of interest in image 1305 may be determined based on marker of interest 1330. Since marker of interest 1330 points out object 1325 from among objects 1315, 1320, and 1325, object 1325 or its corresponding region of image 1305 may be selected as the feature or region of interest in image 1305. Based on this selection, a portion 1335 of the image data associated with image 1305 may be sent external to WHUD 300 for processing. In the depiction of portion 1335 object 1325 is shown in solid lines to indicate that portion 1335 includes a portion of the image data associated with image 1305 corresponding to object 1325, or the region corresponding to object 1325. Moreover, in the depiction of portion 1335, features or regions of image 1305 outside of object 1325, or its associated region, are shown in dashed lines to indicate that in portion 1335 the image data associated with these features or regions outside of object 1325 may be absent, deleted, or otherwise altered.

Furthermore, in some examples, detecting the marker of interest may include detecting one or more human fingers in a predefined orientation in the image. Marker of interest 1330 is an example of human fingers in a predefined orientation. Moreover, another example of human fingers in a predefined orientation may include the index finger and the thumb of one hand forming a C-shape or an open pinching gesture. Such an open pinching gesture may be used to demarcate an entity of interest between the tip of the index finger and the tip of the thumb forming the open pinching gesture.

FIG. 14 shows another example of human fingers in a predefined orientation. In FIG. 14 an image 1405 is captured of a LV 1410 using the camera of WHUD 300. Image 1405 includes a first entity or object 1415 and a second entity or object 1420. Image 1405 also includes images of two human hands 1425 and 1430. In each of these hands, the fingers are in an orientation where the index and thumb of each hand form an L-shape. The L-shape formed by hand 1425 may cooperate with the L-shape formed by hand 1430 to frame or demarcate object 1415. In this manner, object 1415 may be indicated as the object or feature of interest in image 1405. Moreover, in some examples, this manner of demarcation may be used to indicate the region of image 1405 corresponding to entity 1415 as a region of interest in image 1405.

Based on this determination of the entity/object or region of interest in image 1405, a portion 1440 of the image data of image 1405 may be selected and sent external to WHUD 300 for processing. In the depiction of portion 1440 object 1415 is shown in solid lines to indicate that portion 1440 includes the image data corresponding to object 1415 or its corresponding region in image 1405. Moreover, in the depiction of portion 1440 the portions of image 1405 outside of object 1415 are shown in dashed lines to indicate that in portion 1440 the image data corresponding to the portions of image 1405 outside of object 1415 may be absent, deleted, or otherwise altered.

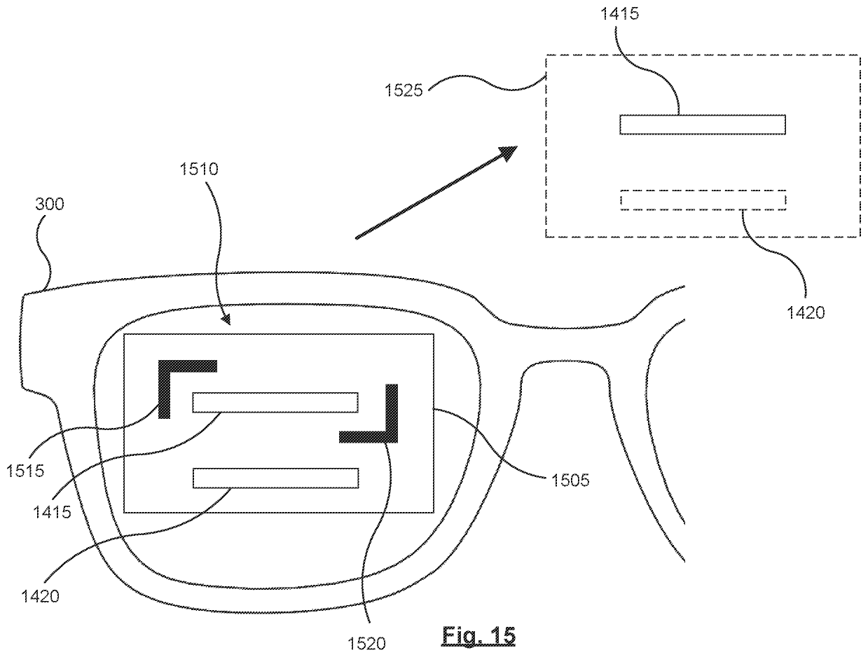

FIG. 15 may be similar to FIG. 14 with a difference being that instead of the hands used in FIG. 14, in FIG. 15 visual markers 1515 and 1520 are added to a live view 1510 as captured by image 1505. For example, if objects 1415 and 1420 are drawings on the whiteboard, visual markers 1515 and 1520 may include drawings made on the same whiteboard. In the example shown in FIG. 15, detecting the marker of interest may include detecting visual markers 1515 and 1520 based on the image data associated with image 1505. Moreover, in some examples, visual markers 1515 and 1520 may be detected using an image recognition module, and the like.

Similar to the hands shown in FIG. 14, visual markers 1515 and 1520 in FIG. 15 indicate object 1415 as the feature of interest in image 1505. Based on this determination of the entity/object or region of interest in image 1505, a portion 1525 of the image data of image 1505 may be selected and sent external to WHUD 300 for processing. In the depiction of portion 1525 object 1415 is shown in solid lines to indicate that portion 1525 includes the image data corresponding to object 1415 or its corresponding region in image 1505. Moreover, in the depiction of portion 1525 the portions of image 1505 outside of object 1415 are shown in dashed lines to indicate that in portion 1525 the image data corresponding to the portions of image 1505 outside of object 1415 may be absent, deleted, or otherwise altered.

Moreover, in some examples, instead of detecting visual markers 1515 and 1520 drawn on a whiteboard, the edges or boundaries of the whiteboard itself may be detected as visual markers indicating that the materials written or drawn on the whiteboard may represent entities or regions of interest. In addition, in some examples, the WHUD may recognize in an image text or other symbols that refer to a referent such as a person, a corporation, an entity, and the like. Based on the identity of the referent, the subject matter of the image may be designated as being of interest.

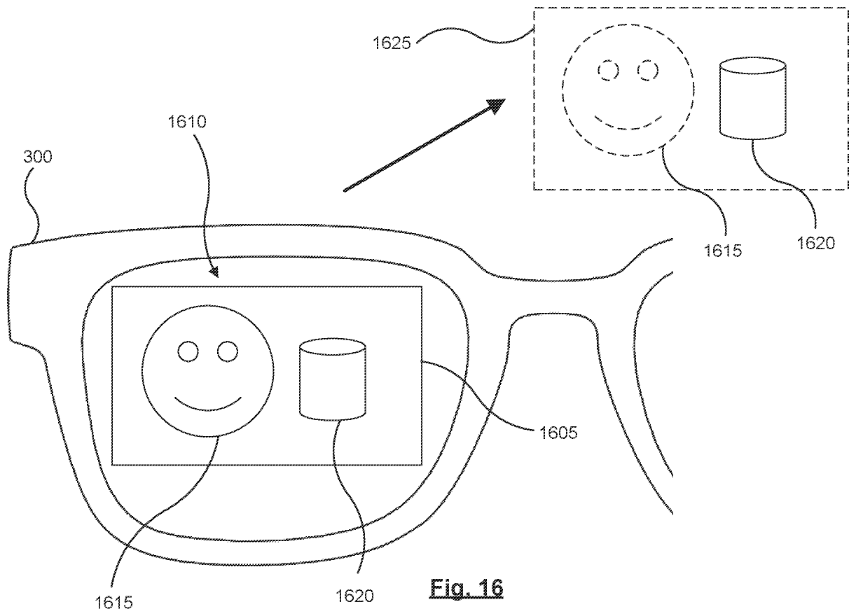

Furthermore, in some examples, the determination of the portion of the image data that is to be sent external to the WHUD may be made based on privacy considerations. In some examples, identity or identifiable content may be excluded from being sent external to the WHUD. Examples of such identity or identifiable content may include faces, nametags, license plates, credit card numbers, and the like. Moreover, in some examples, explicit or graphic content, such as nudity and the like, may also be excluded from being sent external to the WHUD. As mentioned above, faces which may identify individuals may be excluded from the image data sent external to the WHUD. FIG. 16 shows an image 1605 of a LV 1610. Image 1605 includes a face 1615 and an object 1620. As described above, in some examples image data associated with face 1615 may be excluded from a portion 1625 of the image data associated with image 1605 that is sent external to WHUD 300 for processing.

In the depiction of portion 1625, face 1615 is shown in dashed lines to indicate that portion 1625 may exclude the portion of the image data associated with face 1615. Portion 1625 may include the image data corresponding to object 1620, which object 1620 is shown in solid lines in the depiction of portion 1625 to signify the inclusion of the image data of object 1620 in portion 1625. Furthermore, in some examples, image data corresponding to portions of image 1605 outside of face 1615 and object 1620 may also be included in portion 1625. In addition, in some examples, the privacy settings that may cause the exclusion of faces from portion 1625 may be triggered by the operating context or conditions of WHUD 300, such as its location, the application(s) being executed on WHUD 300, input received from the user, and the like.

In some examples, sending the select portion of the image data external to the WHUD may include sending a first portion of the image data corresponding to the region of interest external to the WHUD for processing. In some examples, such a first portion may be similar to the portions sent external to WHUD 300 as described in relation to FIGS. 4-16. Moreover, in some examples, sending the portion of the image data may further include forming an altered second portion by altering a second portion of the image data corresponding to a portion of the image data outside the region of interest. The altered second portion of the image data may then be sent external to the WHUD for processing.

Furthermore, in some examples, altering the second portion may include removing image details or features from the second portion. For example, the second portion may be homogenized by applying a single color or intensity across the second portion to override or erase other image data or details that may have been present in the second portion. Such a homogenization may also be described as “masking” the second portion. In some examples, such a homogenization or masking may render the image data more compressible for sending external to the WHUD, by replacing masked parts of the image data with repeated, efficiently compressible data. Masked or compressing image data in this way may reduce the amount of image data that is sent external to the WHUD. Moreover, such masked or compressed image data may require relatively less adaptive interpretation or other processing when the image data is processed external to the WHUD. For example, masked image data may not be resized, and there may be no need to define excisions from the image data (unlike cropped data, or data where certain portions of the image are deleted). As a result, external processing of such masked data may need less formatting data such as a sidecar file, and the like (or in some cases, formatting data may not be required at all). FIG. 17 shows such an example alteration or masking of an image 1705. In image 1705 a first portion 1710 corresponds to a region of interest, and a second portion 1715 corresponds to the portions of image 1705 outside of first portion 1710. FIG. 17 shows that image data of image 1705 is altered to form altered image data 1720. As shown in FIG. 17, in altered image data 1720 details and information associated with the image data of image 1705 are removed or homogenized corresponding to second portion 1715.

Moreover, in some examples, sending the portion of the image data external to the WHUD may include forming an altered image that by removing from the image data a first portion of the image data corresponding to a portion of the image outside the region of interest. The altered image data may include a second portion of the image data corresponding to the region of interest. The altered image data may then be sent external to the WHUD for processing. FIG. 18 shows an example of such a removal of the image data corresponding to a portion of the image outside the region of interest.

FIG. 18 shows altered image data 1805 formed by altering image data associated with image 1705. In forming altered image data 1805 a portion 1715 of the image data corresponding to a portion of the image outside the region of interest is removed. As such, altered image data 1805 includes only a portion of the image data corresponding to the region of interest.

In some examples, the methods and functions described above such as those described in relation to FIGS. 1 and 4-18 may be performed by a WHUD such as WHUD 300. Furthermore, in some examples, WHUD 300 may include a controller that may control the other components of WHUD 300 to perform the methods and functions described above such as those described in relation to FIGS. 1 and 4-18. In some examples, this controller may be similar to controller 230 of system 200.

The controller may control the camera of the WHUD to capture image data representing an image of a LV in a line of sight of the camera. The controller may also determine an indication of interest associated with the image data. Moreover, the controller may select at least a portion of the image data based on the indication of interest and may send at least the portion of the image data external to the WHUD for processing.

In some examples, to determine the indication of interest, the WHUD may determine a region of interest in the image. Moreover, in some examples, to determine the region of interest, the controller may define at least a portion of the region of interest in the image by defining a boundary associated with a feature of interest in the image. Furthermore, in some examples, to define the boundary the controller may define, in association with the feature of interest, one or more of a bounding box, a set of points, a abounding curve, and the like.

In addition, in some examples, to determine the region of interest the controller may define the region of interest in the image by defining a plurality of boundaries associated with one or more features of interest in the image. The controller may further send external to the WHUD position data associated with the positions of each of the features of interest relative to the image. Moreover, in some examples, to determine the region of interest the controller may designate a central portion of the image as a region of interest. Furthermore, in some examples, to determine the region of interest the controller may determine an application being executed by the controller, and may determine the region of interest based on the application.

Furthermore, in some examples, to determine the region of interest the controller may determine the location of the WHUD, and determine the region of interest based on the location. Moreover, in some examples, to determine the region of interest the controller may receive a user input, and determine the region of interest based on the user input. In addition, in some examples, to determine the region of interest the controller may determine an area of focus in the LV associated with the user, and may determine the region of interest based on the area of focus.

In some examples, the WHUD may further include a gaze tracking module in communication with the controller. The gaze tracking module may be similar to modules 240 and 335 shown in FIGS. 2 and 3 respectively. To determine the area focus, the controller may control the gaze tracking module to determine that the user of the WHUD is gazing at a given region of the image, and may designate the given region as the area focus.

Moreover, in some examples, to determine the region of interest the controller may determine a distance of an entity in a given region of the image from the camera, and may designate the given region as the region of interest if the distance is below a distance threshold. Furthermore, in some examples, to determine the region of interest the controller may determine a presence of text in a given region of the image, and may designate the given region as the region of interest if text is present in the given region.

Furthermore, in some examples, to determine the region of interest the controller may detect at least one marker of interest in the image based on the image data, and may determine the region of interest based on the marker of interest. In some examples, to detect the marker of interest the controller may detect one or more human fingers in a predetermined orientation in the image. Moreover, in some examples, to detect the marker of interest the controller may detect one or more visual markers added to the LV captured in the image. In addition, in some examples, to detect the marker of interest the controller may detect, in the image, a pointer pointing to a portion of the LV. The pointer and the portion of the LV may be captured in the image.

In some examples, to determine the indication of interest the controller may compare the image data with other image data associated with another image captured by the camera. To send the portion of the image data external to the WHUD the controller may send an entirety of the image data external to the WHUD for processing if a difference between the image data and the other image data is greater than a threshold difference. Moreover, in some examples, to determine the indication of interest the controller may detect an entity of interest in the image based on the image data. To send the portion of the image data the controller may send an entirety of the image data external to the WHUD for processing if the entity of interest is detected in the image.

In addition, in some examples, to send the portion of the image data the controller may send a first portion of the image data corresponding to the region of interest external to the WHUD for processing. Moreover, in some examples, to send the portion of the image data the controller may further form an altered second portion by altering a second portion of the image data corresponding to a portion of the image outside the region of interest. The controller may send the altered second portion of the image data external to the WHUD. Furthermore, in some examples, to send the portion of the image data the controller may form an altered image data by removing from the image data a first portion of the image data corresponding to a portion of the image outside the region of interest. The altered image data may include a second portion of the image data corresponding to region of interest. The controller may send the altered image data external to the WHUD for processing.

The controller may perform the functions described above in a manner similar to the functions and features described herein in relation to FIGS. 1 and 4-18.

It is contemplated that method 100 and the other methods described herein may be performed by system 200, WHUD 300, and the other systems and devices described herein. It is also contemplated that method 100 and the other methods described herein may be performed by systems or devices other than the systems and devices described herein. In addition, it is contemplated that system 200, WHUD 300, and the other systems and devices described herein may have the features and perform the functions described herein in relation to method 100 and the other methods described herein. Moreover, system 200, WHUD 300, and the other systems and devices described herein may have features and perform functions other than those described herein in relation to method 100 and the other methods described herein.

In addition, while some of the examples provided herein are described in the context of laser projectors and WHUDs, it is contemplated that the functions and methods described herein may be implemented in or by display systems or devices which may not use laser projectors or be WHUD s.

According to an implementation of the present specification there is provided a method of operating a wearable heads-up display (WHUD), the method including: capturing image data representing an image of a live view (LV) by a camera of the WHUD; determining an indication of interest associated with the image data; selecting at least a portion of the image data based on the indication of interest; and sending the portion of the image data external to the WHUD for processing. The determining the indication of interest may include: determining a region of interest in the image. The determining the region of interest may include: defining at least a portion of the region of interest in the image by defining a boundary associated with a feature of interest in the image. The defining the boundary may include: defining, in association with the feature of interest, one or more of a bounding box, a set of points, and a bounding curve.

The determining the region of interest may include: defining the region of interest in the image by defining a plurality of boundaries associated with one or more features of interest in the image; and the method may further include: sending external to the WHUD position data associated with positions of each of the features of interest relative to the image. The determining the region of interest may include: designating a central portion of the image as the region of interest. The determining the region of interest may include: determining an application being executed by a controller of the WHUD; and determining the region of interest based on the application.

The determining the region of interest may include: determining a location of the WHUD; and determining the region of interest based on the location. The determining the region of interest may include: receiving a user input at the WHUD; and determining the region of interest based on the user input. The determining the region of interest may include: determining an area of focus in the LV associated with a user wearing the WHUD; and determining the region of interest based on the area of focus. The determining the area of focus may include: determining that the user of the WHUD is gazing at a given region of the image; and designating the given region as the area of focus.

The determining the region of interest may include: determining a distance of an entity in a given region of the image from the camera; and designating the given region as the region of interest if the distance is below a distance threshold. The determining the region of interest may include: determining a presence of text in a given region of the image; and designating the given region as the region of interest if the text is present in the given region. The determining the region of interest may include: detecting at least one marker of interest in the image based on the image data; and determining the region of interest based on the at least one marker of interest.

The detecting the at least one marker of interest may include: detecting one or more human fingers in a predefined orientation in the image. The detecting the at least one marker of interest may include: detecting one or more visual markers added to the LV captured in the image. The detecting the at least one marker of interest may include: detecting, in the image, a pointer pointing to a portion of the LV, the pointer and the portion of the LV captured in the image. The determining the indication of interest may include: comparing the image data with other image data associated with another image captured by the camera; and the sending at least the portion of the image data external to the WHUD may include: sending an entirety of the image data external to the WHUD for processing if a difference between the image data and the other image data is greater than a threshold difference.

The determining the indication of interest may include: detecting an entity of interest in the image based on the image data; and the sending at least the portion of the image data may include: sending an entirety of the image data external to the WHUD for processing if the entity of interest is detected in the image. The sending the portion of the image data may include: sending a first portion of the image data corresponding to the region of interest external to the WHUD for processing. The sending the portion of the image data may further include: forming an altered second portion by altering a second portion of the image data corresponding to a portion of the image outside the region of interest; and sending the altered second portion of the image data external to the WHUD.

The sending the portion of the image data may include: forming an altered image data by removing from the image data a first portion of the image data corresponding to a portion of the image outside the region of interest, the altered image data including a second portion of the image data corresponding to the region of interest; and sending the altered image data external to the WHUD for processing. According to another implementation of the present specification there is provided a wearable heads-up display (WHUD) including: a camera; a light engine to generate a display light; a display optic to receive the display light, and direct the display light towards a user of the WHUD to form a display image; and a controller in communication with the camera and the light engine, the controller to: control the camera to capture image data representing an image of a live view (LV) in a line of sight of the camera; determine an indication of interest associated with the image data; select at least a portion of the image data based on the indication of interest; and send at least the portion of the image data external to the WHUD for processing.

To determine the indication of interest the controller may be to: determine a region of interest in the image. To determine the region of interest the controller may be to: define at least a portion of the region of interest in the image by defining a boundary associated with a feature of interest in the image. To define the boundary the controller may be to: define, in association with the feature of interest, one or more of a bounding box, a set of points, and a bounding curve.

To determine the region of interest the controller may be to: define the region of interest in the image by defining a plurality of boundaries associated with one or more features of interest in the image; and the controller may be further to: send external to the WHUD position data associated with positions of each of the features of interest relative to the image. To determine the region of interest the controller may be to: designate a central portion of the image as the region of interest. To determine the region of interest the controller may be to: determine an application being executed by the controller; and determine the region of interest based on the application.

To determine the region of interest the controller may be to: determine a location of the WHUD; and determine the region of interest based on the location. To determine the region of interest the controller may be to: receive a user input; and determine the region of interest based on the user input. To determine the region of interest the controller may be to: determine an area of focus in the LV associated with the user; and determine the region of interest based on the area of focus.

The WHUD may further include a gaze tracking module in communication with the controller; and to determine the area of focus the controller may be to: control the gaze tracking module to determine that the user of the WHUD is gazing at a given region of the image; and designate the given region as the area of focus. To determine the region of interest the controller may be to: determine a distance of an entity in a given region of the image from the camera; and designate the given region as the region of interest if the distance is below a distance threshold.

To determine the region of interest the controller may be to: determine a presence of text in a given region of the image; and designate the given region as the region of interest if text is present in the given region. To determine the region of interest the controller may be to: detect at least one marker of interest in the image based on the image data; and determine the region of interest based on the at least one marker of interest.

To detect the at least one marker of interest the controller may be to: detect one or more human fingers in a predefined orientation in the image. To detect the at least one marker of interest the controller may be to: detect one or more visual markers added to the LV captured in the image. To detect the at least one marker of interest the controller may be to: detect, in the image, a pointer pointing to a portion of the LV, the pointer and the portion of the LV captured in the image. To determine the indication of interest the controller may be to: compare the image data with other image data associated with another image captured by the camera; and to send at least the portion of the image data external to the WHUD the controller may be to: send an entirety of the image data external to the WHUD for processing if a difference between the image data and the other image data is greater than a threshold difference.

To determine the indication of interest the controller may be to: detect an entity of interest in the image based on the image data; and to send at least the portion of the image data the controller may be to: send an entirety of the image data external to the WHUD for processing if the entity of interest is detected in the image. To send the portion of the image data the controller may be to: send a first portion of the image data corresponding to the region of interest external to the WHUD for processing. To send the portion of the image data the controller may be further to: form an altered second portion by altering a second portion of the image data corresponding to a portion of the image outside the region of interest; and send the altered second portion of the image data external to the WHUD.

To send the portion of the image data the controller may be to: form an altered image data by removing from the image data a first portion of the image data corresponding to a portion of the image outside the region of interest, the altered image data including a second portion of the image data corresponding to the region of interest; and send the altered image data external to the WHUD for processing.

Throughout this specification and the appended claims, infinitive verb forms are often used. Examples include, without limitation: “to generate,” “to receive,” “to capture,” “to determine,” and the like. Unless the specific context requires otherwise, such infinitive verb forms are used in an open, inclusive sense, that is as “to, at least, generate,” to, at least, receive,” “to, at least, capture,” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method comprising:
capturing image data representing an image of a live view (LV) by a camera of a wearable heads-up display (WHUD);
selecting at least a portion of the image data based an indication of interest associated with the image data; and
sending the portion of the image data external to the WHUD for processing.

2. The method of claim 1, wherein the indication of interest comprises a region of interest in the image.

3. The method of claim 2, further comprising:
defining at least a portion of the region of interest in the image by defining a boundary associated with a feature of interest in the image.

4. The method of claim 3, wherein the defining the boundary comprises:
defining, in association with the feature of interest, one or more of a bounding box, a set of points, and a bounding curve.

5. The method of claim 2, further comprising determining the region of interest, including:
defining the region of interest in the image by defining a plurality of boundaries associated with one or more features of interest in the image.

6. The method of claim 2, further comprising determining the region of interest based on an application being executed by a processor associated with the WHUD.

7. The method of claim 2, further comprising determining the region of interest based on a location of the WHUD.

8. The method of claim 2, further comprising determining the region of interest based on a user input at the WHUD.

9. The method of claim 2, further comprising determining the region of interest based on an area of focus in the LV associated with a user of the WHUD.

10. The method of claim 9, wherein the area of focus is based on a determination that the user gazing at a given region of the image.

11. The method of claim 2, further comprising determining the region of interest based on a distance of an entity in a given region of the image from the camera.

12. The method of claim 2, further comprising determining the region of interest based a presence of text in a given region of the image.

13. The method of claim 2, further comprising determining the region of interest based on at least one marker of interest in the image based on the image data.

14. The method of claim 13, wherein the at least one marker of interest comprises one or more human fingers in a predefined orientation in the image.

15. The method of claim 2, wherein the sending the portion of the image data comprises:
sending a first portion of the image data corresponding to the region of interest external to the WHUD for processing.

16. The method of claim 15, wherein the sending the portion of the image data further comprises:
forming an altered second portion by altering a second portion of the image data corresponding to a portion of the image outside the region of interest; and
sending the altered second portion of the image data external to the WHUD.

17. A wearable heads-up display (WHUD) comprising:
a camera;
a light engine to generate a display light;
a display optic to receive the display light, and direct the display light towards a user of the WHUD to form a display image; and
a controller in communication with the camera and the light engine, the controller to:
control the camera to capture image data representing an image of a live view (LV);
select at least a portion of the image data based an indication of interest associated with the image data; and
send the portion of the image data external to the WHUD for processing.

18. The WHUD of claim 17, wherein the controller is to:
determine an application being executed by the controller; and
determine the region of interest based on the application.

19. The WHUD of claim 17, wherein the controller is to:
determine a location of the WHUD; and
determine the region of interest based on the location.

20. A wearable heads-up display (WHUD) comprising:
a camera;
a light engine to generate a display light;
a display optic to receive the display light, and direct the display light towards a user of the WHUD to form a display image; and
a controller in communication with the camera and the light engine, the controller to:
control the camera to capture image data;
send the portion of the image data external to the WHUD for processing, the portion of the image data based on an indication of interest associated with the image data.
